(19) United States
(12) Patent Application Publication
(10) Pub. No.: US 2026/0368452 A1
(43) Pub. Date: Nov. 19, 2026

(54) Systems and Methods for Video-Driven Diffusion for Cross-Lingual Dubbing

(71) Applicant: Google LLC, Mountain View, CA (US)

(72) Inventors: Michelle Dana Tadmor-Ramanovich, Tel Aviv (IL); Alon Levkovitch, Givatayim (IL); Daniel Walevski, Tel Aviv (IL); Anja Hauth, Baar (CH); Julian Emilio S. Salazar, San Francisco, CA (US)

(21) Appl. No.: 19/210,743

(22) Filed: May 16, 2025

(51) Int. Cl. G06F 40/58; G10L 13/027; G10L 25/18; G11B 27/031

(52) U.S. Cl. CPC G06F 40/58; G10L 13/027; G10L 25/18; G11B 27/031

(57) ABSTRACT

Systems and methods for video-driven diffusion for cross-lingual dubbing are provided. The method includes receiving, by a computing system, input data including a textual embedding, a video embedding, and one or more speaker embeddings; generating, by the computing system, a noised latent representation; processing, by a diffusion model operating on the computing system, the textual embedding, the video embedding, the one or more speaker embeddings, and the noised latent representation to produce a noise prediction; generating, by the computing system, a denoised latent representation from the noised latent representation based on the noise prediction; and decoding, by a latent decoder operating on the computing system, the denoised latent representation to produce an output spectrogram representative of audio data in a second language; and converting, by a vocoder operating on the computing system, the output spectrogram into the audio data.

### FIELD

The present disclosure relates generally to systems and methods for video-driven diffusion for cross-lingual dubbing.

### BACKGROUND

The rapid growth of global video content has created a strong demand for multilingual dubbing, allowing audiences to experience media in their native languages. Traditionally, dubbing has required a labor-intensive process involving human translators, voice actors, and sound engineers to re-record dialogue in the target language while synchronizing with visual cues. This costly and time-consuming approach limits scalability on content-rich platforms like streaming services and online education, highlighting the need for automated solutions that can efficiently make media accessible across languages.

Automatic Video Dubbing (AVD) has emerged to meet this demand by automating dubbing workflows. Generally, AVD methods fall into two categories: one that generates speech matching the original spoken words, often for silent or re-recorded videos, and another that translates and dubs content across languages.

Cross-lingual dubbing may introduce specific challenges in translation accuracy and natural synchronization with visual cues. Cross-lingual dubbing pipelines are commonly composed of Automatic Speech Recognition (ASR) to retrieve transcripts, Neural Machine Translation (NMT) to translate text into the target language, and Text-to-Speech (TTS) to synthesize speech in the target language. These pipelines, however, face additional challenges unique to videos: speech must be temporally aligned with the original visual cues (e.g., lip movements and gestures), and the dubbed audio should respect the overall duration and pacing of the original content.

Accordingly, improved systems and methods for cross-lingual dubbing are desired in the art. In particular, systems and methods for cross-lingual dubbing that are aligned with the original video would be advantageous.

### BRIEF DESCRIPTION

Aspects and advantages of the disclosure in accordance with the present disclosure will be set forth in part in the following description, or may be obvious from the description, or may be learned through the practice of the technology. [This section will be completed by patent counsel. For reasons of legal strategy, it will simply include a restatement of the claims in paragraph form.]

These and other features, aspects, and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIGS. 1A-B depict a block diagram of an exemplary framework of video-driven diffusion for cross-lingual dubbing according to example implementations of aspects of the present disclosure;

FIG. 2 depicts a block diagram of an exemplary diffusion model according to example implementations of aspects of the present disclosure;

FIG. 3 depicts a flow diagram of an exemplary method for video-driven diffusion for cross-lingual dubbing according to example implementations of aspects of the present disclosure;

FIG. 4 is a flow chart diagram illustrating an example method for training a machine-learned model according to example implementations of aspects of the present disclosure;

FIG. 5 is a block diagram of an example processing flow for using machine-learned model(s) to process input(s) to generate output(s) according to example implementations of aspects of the present disclosure;

FIG. 6 is a block diagram of an example sequence processing model according to example implementations of aspects of the present disclosure;

FIG. 7 is a block diagram of an example technique for populating an example input sequence for processing by a sequence processing model according to example implementations of aspects of the present disclosure;

FIG. 8 is a block diagram of an example model development platform according to example implementations of aspects of the present disclosure;

FIG. 9 is a block diagram of an example training workflow for training a machine-learned model according to example implementations of aspects of the present disclosure;

FIG. 10 is a block diagram of an inference system for operating one or more machine-learned model(s) to perform inference according to example implementations of aspects of the present disclosure;

FIG. 11 is a block diagram of an example networked computing system according to example implementations of aspects of the present disclosure;

FIG. 12 is a block diagram of an example computing device according to example implementations of aspects of the present disclosure; and

FIG. 13 is a block diagram of an example computing device according to example implementations of aspects of the present disclosure.

### DETAILED DESCRIPTION

Generally, systems and methods for video-driven diffusion for cross-lingual dubbing are disclosed. In some examples, the system receives input data including a textual embedding, a video embedding, one or more speaker embeddings, and, when performing training, a first spectrogram representing audio in a first language. The first spectrogram is a digital representation of the frequency and temporal structure of the original audio signal of a source video. This spectrogram captures elements of the audio like pitch, tone, and rhythm.

Once the input data is received, the computing device processes, during training, the first spectrogram to produce a noised latent representation. This operation can include deliberately adding noise to the data to improve the model's ability to generalize and avoid overfitting. The noised latent representation serves as a distorted version of the original audio representation. Additionally, the noised latent representation is a representation of the first spectrogram in latent space. Alternatively, during inference, the noised latent representation can be generated from a noise distribution (e.g., a Gaussian noise distribution).

Systems and methods disclosed herein can include a diffusion model. The diffusion model is configured to process the textual embedding, video embedding, speaker embeddings, and the noised latent representation to generate a noise prediction. The diffusion model may be trained to predict the noise that has been added to the first spectrogram, which may enable the diffusion model to predict noise to remove from a random noise input to produce an appropriate output. The integration of the textual embedding, video embedding, and speaker embedding allows the model to produce an accurate noise prediction. The predicted noise can be removed to result in a denoised latent representation.

In some implementations, the prediction and removal of noise can occur iteratively over a number of diffusion time steps. These steps may include both forward diffusion process and backward diffusion process. During the forward diffusion process, noise may be added to the latent representation, gradually transforming the input into a noised latent representation. The backward diffusion process works in the reverse direction, progressively removing noise based on the model's noise predictions to generate a denoised latent representation that aligns with the target spectrogram in the second language.

In some embodiments, the number of diffusion steps may be treated as a hyperparameter, allowing for fine-tuning of the model based on various design considerations. In a non-limiting example, a larger number of steps may result in higher-quality outputs but at the cost of increased computational time, while fewer steps can speed up processing but may risk losing fine-grained audio details. Alternatively, the number of steps may be adjusted based on criteria such as output quality, computational cost, or real-time processing constraints. In certain cases, the process can be terminated early if a certain confidence threshold or quality metric is met.

Systems and methods disclosed herein also include decoding, using a latent decoder, the denoised latent representation to generate a second spectrogram. The second spectrogram may represent the audio of the source video translated into a second language. That is, the second spectrogram may represent translated audio. The latent decoder is configured to generate the second spectrogram from the denoised latent representation.

Once the second spectrogram is generated, it may be transmitted to a vocoder to convert the spectrogram into audio data. The vocoder synthesizes the final audio signal by mapping the spectral features back to a time-domain waveform, resulting in high-quality speech in the second language.

The systems and methods of the present disclosure provide a number of technical effects and benefits. As one example, the system can process video frames as direct conditioning signals for generating speech, thus automating the alignment of timing and lip movements. For instance, in some implementations, the diffusion-based architecture can receive stream of video frames, extracting their motion features to guide the speech output. This enables precise synchronization between audio and visual cues in cross-lingual dubbing, thereby offering a technical advantage that may reduce the need for separate lip animation modules or complex manual coordination routines.

If the need for separate lip animation modules are reduced or eliminated, fewer computational resources, e.g., measured in data bandwidth, data storage costs, processing cycles, and so on, may be needed in post-processing for a given dubbed video. Fewer computational resources can allow an appropriately configured system of devices to dub videos faster, as well as dub more videos in the same amount of time, all while maintaining precise synchronization between audio and visual cues, as described herein.

As another example of a technical benefit, the non-auto-regressive speech synthesis approach can eliminate explicit duration prediction, improving computational efficiency. In some implementations, the model learns timing cues directly from the input video segments, allowing it to capture natural pauses, pacing shifts, and speech dynamics without relying on dedicated duration estimators. This approach not only speeds up the synthesis process by avoiding the need for time-intensive duration modeling, but it also reduces memory overhead, as the model can process entire sequences in parallel rather than step by step. By removing the dependency on explicit duration prediction, the system can avoid the computational costs associated with frame-level alignment and timing estimation, which typically scale with the length of the input. Additionally, eliminating explicit duration prediction may simplify the model architecture, reducing the number of hyperparameters and training steps required to achieve high-quality outputs. This approach may allow the system to focus more on acoustic consistency and speaker identity rather than explicit duration prediction.

As yet another example technical benefit, the architecture can include a combination of trained encoders for text and video, which are integrated within a diffusion framework to produce high-fidelity speech signals. In some implementations, these encoders transform raw data into latent embeddings that guide the diffusion process, ensuring consistent speaker identity and stable acoustic features. This consistency in speaker identity and acoustic stability can improve cross-dubbing by maintaining the unique vocal characteristics of the speaker across different languages. Thereby reducing the need for extensive manual adjustment and enhancing the overall coherence of the audio-visual output.

Further benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

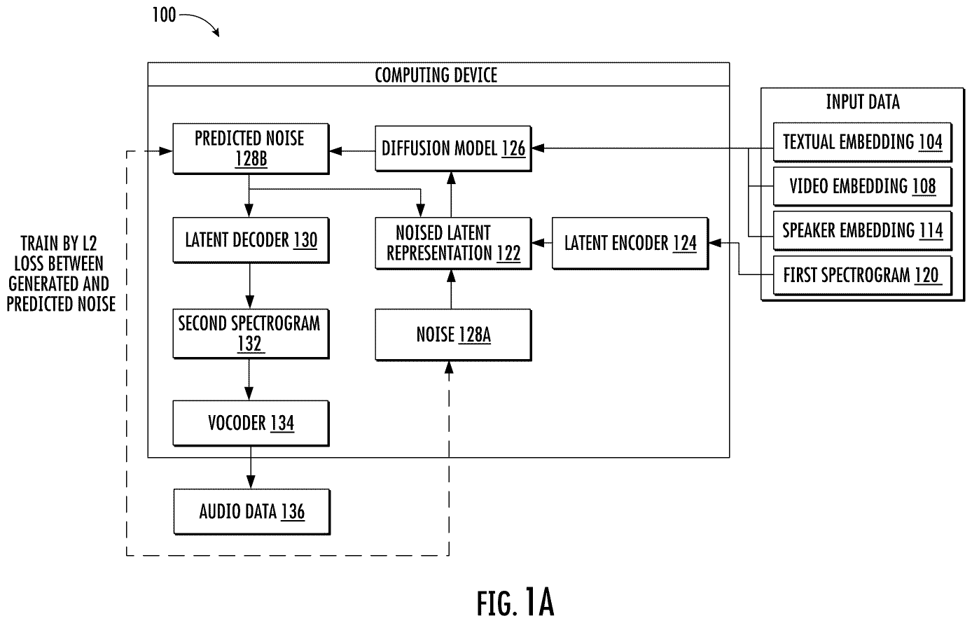

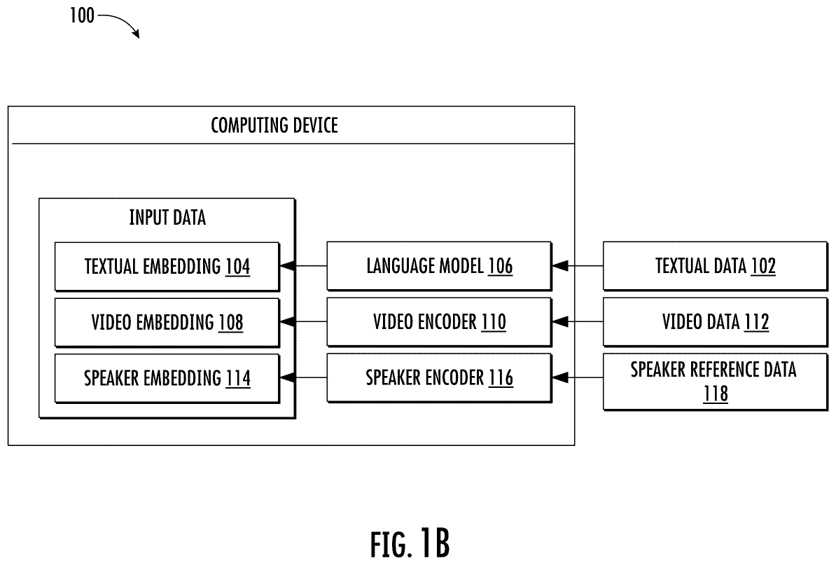

Referring now to the drawings, FIGS. 1A-B illustrate an exemplary block diagram of a system 100 for video-driven diffusion for cross-lingual dubbing. FIGS. 1A-B include textual data 102, textual embedding 104, language model 106, video embedding 108, a video encoder 110, video data 112, one or more speaker embeddings 114, speaker encoder 116, speaker reference data 118, a first spectrogram 120, a noised latent representation 122, latent encoder 124, a diffusion model 126, noise prediction 128, a latent decoder 130, a second spectrogram 132, a vocoder 134, audio data 136, and the like.

Operations the system 100 is configured to perform include receiving input data that includes a textual embedding 104. The textual embedding 104 is a representation of the textual data 102 in a form that a computing device or model can process and understand more effectively. The textual embedding 104 may be used to capture the meaning, context, and relationships between words and phrases within the textual data 102. Each element of the textual embedding 104 encodes specific features of the text, such as its semantic meaning, syntactic structure, and contextual relevance.

As used in the current disclosure, textual data 102 refers to a written representation of the spoken words within the video content. The textual data 102 may also include written representation of sounds and sometimes non-verbal cues that occur within the video. The textual data can include a transcription of the words spoken during the video. In some cases, the textual data 102 can include timestamps, speaker identification, closed captions, subtitles, and the like. This can include descriptions of significant sounds, like music, background noise, or emotional tone that help convey the overall message of the video.

The operations can include processing, using a language model 106 operating on the computing device, textual data 102 to generate the textual embedding 104. In some implementations, the language model 106 is a type of machine learning model designed to generate textual embeddings 104 from textual data 102. The language model 106 may use a number of deep learning techniques. The language model 106 may be configured to use layers of attention mechanisms to weigh the importance of different parts of the input text, allowing them to consider not just individual words but their relationships with other words across a larger context. This enables the model 106 to handle ambiguity, idiomatic expressions, and complex sentence structures.

The language model 106 may be configured to analyze the textual data 102 by considering the context of each word in relation to the others. The language model 106 may be configured to assign one or more values to each of the words, phrases, or sentences based on their contextual relationships, which then may be transformed into a multi-dimensional vector, which may also be referred to as an “embedding”, such as textual embedding 104. This vector may encapsulate the semantic content of the text, enabling the system to compare it with other embeddings to measure similarity, identify patterns, or extract meaningful features from the text.

The language model 106 may be trained on vast amounts of textual data 102 to learn the syntactic and semantic properties of language. By capturing complex relationships between words, phrases, sentences, and paragraphs, the language model 106 can translate textual data 102 into a textual embedding 104 that reflects not just the literal meaning but also the deeper, contextual nuances of the content. In some cases, the language model 106 may be jointly trained or optimized with other machine learning models discussed herein.

With continued reference to FIGS. 1A-B, the operations can include receiving input data that includes a video embedding 108. In some implementations, the video embedding 108 is a vector representation that encapsulates the essential information and features of the source video.

Receiving the video embedding 108 can include processing, using a video encoder 110 operating on the computing device, video data 112 to generate the video embedding 108. As used in the current disclosure, video data 112 refers to a collection of visual information that is represented by a series of video frames or images captured sequentially over time. Video data 112 may be represented as a series of frames, each frame being a distinct image captured at a specific time interval (usually measured in frames per second or FPS). Each frame can include pixel data, which represents the colors, brightness, and textures of objects within the video. These frames, when viewed together, create the visual narrative of the video.

The video encoder 110 is configured to process the video data 112 to generate the video embedding 108. In some implementations, the video encoder 110 is a machine learning model that is configured to generate video embeddings 108 based on the video data 112. An exemplary video encoder 110 can include a Variational Autoencoder (VAE), which is a type of deep learning model used for unsupervised learning tasks. The video encoder 110 may be configured to take raw video data 112 as an input and transform it into a video embedding 108. The video encoder 110 may work by encoding the video data 112 into a lower-dimensional latent space while preserving the essential features of the video, such as objects, actions, and temporal changes.

The video encoder 110 may be trained to compress the video data 112 into a set of parameters that define a distribution in the latent space. Rather than producing a single fixed output, the video encoder may output a distribution represented by a mean and a variance, from which a latent vector is sampled. This latent vector may serve as the video embedding 108. The video embedding 108 may capture both the visual content of individual frames and the temporal dynamics of the video data (e.g., how the frames evolve over time).

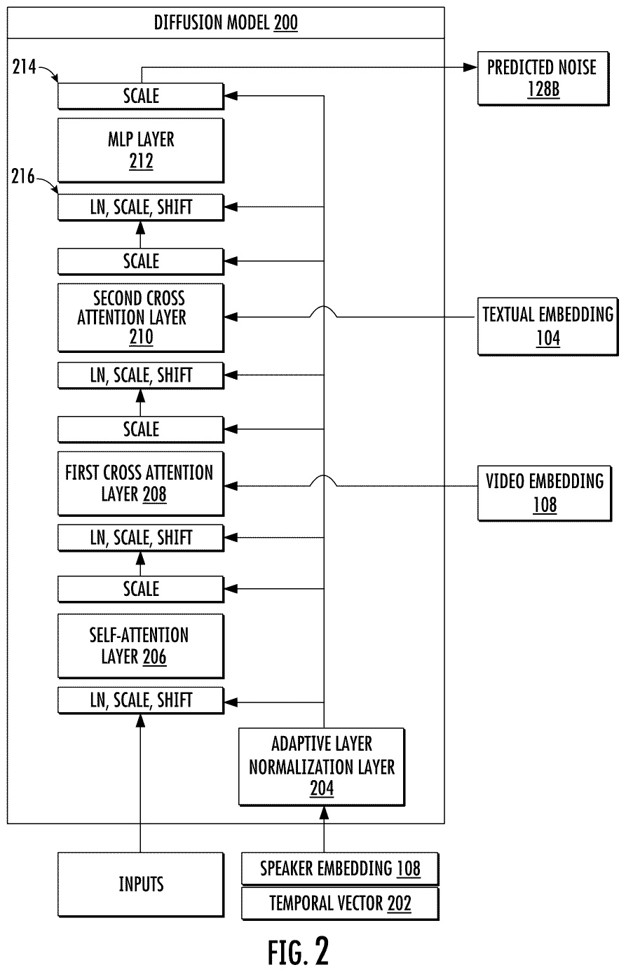

The video encoder 110 may be trained using a combination of L2 loss, adversarial loss, and KL divergence regularization to optimize its performance in generating accurate video embeddings 108. The L2 loss may be employed to minimize the difference between the original video and its reconstructed version, ensuring that the video encoder 110 accurately captures the essential features of the video. Adversarial loss is introduced by incorporating a discriminator that attempts to distinguish between real and generated video embeddings, encouraging the encoder to produce video embeddings 108 that are indistinguishable from true data. KL divergence regularization is used to ensure that the distribution of the latent space (represented by the mean and variance output by the video encoder 110) is close to a predefined normal distribution, promoting smoothness and consistency in the latent space. Together, these loss functions guide the training process of the video encoder 110. The video encoder 110 may be jointly trained or optimized with other machine learning models discussed herein. The joint optimization of the models will be discussed in greater detail herein below in FIG. 2.

With continued reference to FIGS. 1A-B, the operations can include receiving input data that includes one or more speaker embeddings 114. As used in the current disclosure, a speaker embedding 114 is a vector representation of an individual's voice. These speaker embeddings 114 serve as numerical or vectorized representations of a speaker's vocal traits. The speaker embeddings 114 may be able to encapsulate one or more unique aspects of a speaker's voice in a way that remains consistent across different recordings or environments. This can include aspects such as a speaker's vocal characteristics (e.g., accent, tone, and speaking style.)

In an embodiment, receiving the one or more speaker embeddings 114 can include processing, using a speaker encoder 116 operating on the computing device, speaker reference data 118 to generate the one or more speaker embeddings. Speaker reference data 118 can include short audio clips that are associated with each individual speaker. The speaker reference data 118 may be used to identify and distinguish individual speakers in a larger corpus of audio or video content. These audio clips may contain a sample of the speaker's voice. In some cases, this sample may be anywhere between 1-10 seconds in length, in some cases the speaker reference data 118 can include a 1.5-second clip of the speaker's voice. Speaker reference data 118 may be extracted from the source video or generated/received from a secondary source.

The speaker reference data 118 may be represented by a spectrogram. A spectrogram may refer to a 2D image where one axis represents time, the other represents frequency, and the intensity of color or brightness at each point indicates the strength of a particular frequency at a specific moment. Speaker reference data 118 represented as a spectrogram may capture the temporal and spectral characteristics of the speaker's voice in a format that is conducive to machine learning. The spectrogram may be used to capture various information relating to the speaker's voice such as information about the speaker's vocal traits, such as pitch, tone, rhythm, and unique speech patterns.

The speaker encoder 116 is a machine learning model configured to process speaker reference data 118 and convert it into a speaker embedding 114. Processing of the speaker reference data 118 can result in one or more embeddings, each capturing different speakers within the audio. In an embodiment, the speaker encoder 116 may be implemented using a ResNet (Residual Networks) architecture, where ResNet architecture is a type of deep convolutional neural network (CNN). The speaker encoder 116 may be trained to map the speaker reference data 118 into a high-dimensional space where each point in that space represents the unique characteristics of the speaker's vocal identity. The speaker encoder 116 may work by processing the raw audio or its transformed representation (such as a spectrogram) through multiple layers of convolutional filters. These filters progressively capture different levels of abstraction from the data, ranging from low-level features such as edges and textures in the frequency domain to higher-level features such as patterns of speech, tone, and pitch. As the data passes through these layers, the speaker encoder 116 learns to focus on the most important characteristics of the speaker's voice.

The speaker encoder 116 may be trained using a large dataset of audio recordings, where each recording is labeled with the corresponding speaker's identity. During training, the model learns to map the speaker reference data 118 into unique, fixed-size vector representations. The training process can include one or more supervised learning techniques, where the model is provided with labeled examples of speaker reference data 118 and their associated speaker identities. The speaker encoder 116 uses these labeled samples to learn to extract features that are representative of a speaker's voice, such as pitch, tone, and cadence.

As one example, the training process for the speaker encoder 116 may be optimized with a loss function such as contrastive loss or triplet loss. These loss functions encourage the speaker encoder 116 to produce similar embeddings for speaker reference data 118 from the same speaker and distinct embeddings for speaker reference data 118 from different speakers. Additionally, the model may be regularized using techniques like data augmentation (e.g., introducing background noise or varying the pitch) to improve generalization and robustness across different environments and recording conditions. As the model learns from the diverse range of speaker reference data 118, it gradually refines its ability to map voice features.

With continued reference to FIGS. 1A-B, the operations can include receiving input data including a first spectrogram 120. For example, the first spectrogram 120 can be received when performing training of the diffusion model 126 and/or the latent encoder 124 and/or the latent decoder 130. The first spectrogram can be a visual representation of the frequency content of the audio in a source video. The first spectrogram may serve as a representation of the spoken content in the source video. The first spectrogram may be used to capture the acoustic features of the speech, such as vowel and consonant sounds, speech cadence, and phonetic patterns unique to that language or audio. The first spectrogram 120 may be created by converting the raw audio signal into a spectrogram.

The first spectrogram 120 may represent the audio of the source video in a first language. The first language can include, but is not limited to, languages such as English, Mandarin Chinese, Hindi, Spanish, French, Arabic, Bengali, Russian, Portuguese, Urdu, Indonesian, German, Japanese, Swahili, Marathi, Telugu, Turkish, Korean, Tamil, Vietnamese, Hausa, and the like. A person who is skilled in the art should understand that this is not an exhaustive list of potential first languages, but rather an exemplary list of first languages.

With continued reference to FIGS. 1A-B, the operations can include processing, by the computing device, the first spectrogram 120 to produce a noised latent representation 122. The noised latent representation 122 can be, in this case, a modified version of the first spectrogram 120, where noise has been intentionally introduced to the data and the spectrogram has been transformed into latent space. This noise can take many forms, including random variations in the frequency or amplitude, background noise, or distortion introduced through various processing techniques. By adding noise, the model is forced to learn how to identify essential patterns and features of the audio despite the added complexity. Alternatively, during an inference application of the illustrated system, the noised latent representation 122 can be generated from a noise distribution (e.g., a Gaussian noise distribution).

The noised latent representation 122 may be a latent representation of the data because it is an abstracted, lower-dimensional version of the original spectrogram that has undergone transformation or compression. The first spectrogram 120 may be encoded into a latent space, which is a compressed, more compact form that retains the most important features for further processing. When noise is introduced to the latent space, it alters the original, clean spectrogram by adding disturbances that challenge the model to extract key features even in the presence of imperfections. This process can help prevent the model from overfitting to clean, ideal data, forcing it to generalize better to diverse inputs.

The noised latent representation 122 may be generated using a latent encoder 124. In some implementations, the latent encoder 124 is a machine learning model or algorithm designed to transform the first spectrogram into a latent representation within the latent space. The role of the latent encoder 124 may be capturing and compressing the key features of the first spectrogram 120, while discarding less relevant information.

To generate the noised latent representation 122, the latent encoder 124 introduces intentional noise into the latent representation during the encoding process. Noise 128A is typically added in the form of random perturbations or distortions to the encoded features, which can affect various aspects of the spectrogram, such as the amplitude, frequency, or temporal patterns. The introduction of noise 128A can be achieved through various techniques, such as adding Gaussian noise, dropout, or other forms of random alterations that simulate real-world imperfections in the audio.

With continued reference to FIGS. 1A-B, system 100 includes a diffusion model 126. In some implementations, the diffusion model is a type of generative model used for data generation by learning how to reverse the process of adding noise to data. The diffusion model 126 is configured to generate predicted noise 128B associated with the noised latent representation 122. The objective of the diffusion model 126 can include learning how to predict and remove the added noise from the noised latent representation 122 by reversing the diffusion process.

Inputs into the diffusion model 126 can include the textual embedding 104, the video embedding 108, the one or more speaker embeddings 114, and the noised latent representation 122. The outputs to the diffusion model 126 can include the predicted noise 128B.

The diffusion model 126 may be trained by progressively adding noise to spectrograms within the training data over several steps, creating a noisy version of the original data. By training using this process, the diffusion model 126 learns the reverse diffusion path, which can then be used for generating new data or making predictions. Thus, in the inference stage, the diffusion model 126 may be configured to learn how to reverse this process by starting with a noisy version of the data (e.g., noised latent representation 122) and gradually removing noise, step-by-step, to reconstruct an alternate version of the original data.

The diffusion model 126 may operate through a series of transformations where, at each step, it refines its estimate of the predicted noise 128 in the noised latent representation 122. These transformations may be predicted by a neural network, which is trained to predict the noise at each step of the reverse process. The diffusion model 126 may be trained on a large dataset, where it learns the patterns of noise across different spectrograms and can generalize this knowledge to handle new, unseen data.

With continued reference to FIG. 1A, the operations include processing, by the diffusion model 126 operating on the computing device, the textual embedding 104, the video embedding 108, the one or more speaker embeddings 114, and the noised latent representation 122 to produce a noise prediction 128A. The diffusion model 126 may be used to reverse a diffusion process where noise is gradually added to the latent representation over time. The predicted noise 128A is the model's estimation of this noise at each step of the reverse diffusion process, generated as the model works to “clean” or denoise the noisy input.

With continued reference to FIGS. 1A-B, the operations can include decoding, by a latent decoder 130, the noised latent representation 122 based on the noise prediction 128B to produce a second spectrogram 132, which represents the audio in a second language.

Specifically, the predicted noise 128B can be removed from the noised latent representation 122 to generate a denoised latent representation (not specifically illustrated). The latent decoder 130 can then decode the denoised latent representation into the second spectrogram 132.

In some implementations, the second spectrogram 132 is a refined audio representation that results from the decoding process of the latent decoder 130. It serves as the spectrogram output that represents the translated speech in a second language. This spectrogram is generated after the noised latent representation 122 undergoes a structured denoising process guided by noise prediction 128B. The goal of this transformation is to preserve the original speech's acoustic characteristics, such as speaker identity and prosody, while ensuring that the linguistic content is accurately translated into the target language. Where the target language or second language can include, but is not limited to, languages such as English, Mandarin Chinese, Hindi, Spanish, French, Arabic, Bengali, Russian, Portuguese, Urdu, Indonesian, German, Japanese, Swahili, Marathi, Telugu, Turkish, Korean, Tamil, Vietnamese, Hausa, and the like. A person who is skilled in the art should understand that this is not an exhaustive list of potential second languages, but rather an exemplary list of second languages.

The second spectrogram 132 may be configured to retain essential speech features, such as intonation, rhythm, phoneme timing, and spectral energy distribution. This is done to ensure that the translated speech remains intelligible and expressive. Since different languages have unique phonetic structures and prosodic patterns, the second spectrogram 132 may be constructed to reflect these variations while maintaining speaker consistency.

In some embodiments, the latent decoder 130 may incorporate autoregressive models, attention mechanisms, or generative adversarial networks (GANs) to map latent representations into meaningful acoustic features within the second spectrogram 132. This mapping ensures that key speech elements (e.g., intonation, rhythm, and phoneme timing) may be preserved while aligning with the phonetic and prosodic characteristics of the second language.

With continued reference to FIGS. 1A-B, the operations include converting, by a vocoder 134 operating on the computing device, the second spectrogram 132 into audio data 136. The vocoder can be a signal-processing tool used in speech synthesis and modification. The vocoder 134 may be employed to transform or generate audio signals from spectral representations like spectrograms. It analyzes the input audio (e.g., the second spectrogram 132) and converts it into a waveform, which can then be played as a sound. Thus, the vocoder can act as a bridge between the high-level, frequency-domain features (such as the second spectrogram 132) and the time-domain audio signal (the audio data 136).

The vocoder 134 may take the second spectrogram 132 and use it to generate a time-domain signal, essentially reconstructing the audio waveform. The second spectrogram 132 may provide a detailed map of how the signal's frequency components evolve over time, including information about pitch, amplitude, and spectral content. The vocoder can work by taking these frequency-domain representations and converting them into the audio waveform, ensuring that the output sound has the desired characteristics, such as the correct intonation, rhythm, and phonetic structure.

Referring now to FIG. 2, an exemplary embodiment of a diffusion model in accordance with the present disclosure. The diffusion model of FIG. 2 may be the same or substantially similar to the diffusion model 126 of FIGS. 1A-B. The diffusion model 200 can include several blocks or layers. Specifically, the diffusion model 200 can include an adaptive layer normalization layer 204, a self-attention layer 206, a first cross-attention layer 208, a second cross-attention layer 210, a multi-layer perception (MLP) layer 212, and the like. Information may be processed by each layer as it passes through the stack of layers.

The diffusion model 200 can include an adaptive layer normalization layer 204. In some embodiments, the adaptive layer normalization layer 204 can include an AdaLN (Adaptive Layer Normalization) layer. This model can perform adjustments to the characteristics (e.g., mean and variance) according to the specific features of the input data.

The adaptive layer normalization layer 204 may be configured to receive multiple inputs, including the temporal vector 202 and the speaker embedding 114. The temporal vector 202 represents a digital encoding of the time-dependent features of the data, while the speaker embedding captures speaker-specific characteristics. These inputs allow the adaptive layer normalization layer 204 to modulate the feature space at each block within the diffusion model 200, including the self-attention layer 206, the first and second cross-attention layers 208 and 210, and the multi-layer perception (MLP) layer 212. The adaptive layer normalization layer 204 may iteratively adjust or fine-tune the normalization parameters at each layer to refine the learned representations according to temporal and speaker-specific contexts.

At each layer of the diffusion model 200, the adaptive layer normalization layer 204 may incorporate the temporal vector 202 and speaker embedding 114 into the data processing. This ensures that the transformations applied at each block, such as noise removal or feature extraction, are adjusted based on the time context and speaker identity. For example, the temporal vector 202 can influence how the model focuses on short-versus long-term features, while the speaker embedding 114 may be used to tailor the model's handling of phonetic or acoustic patterns.

With continued reference to FIG. 2, the diffusion model 200 can include one or more scale operators 214 and shift operators 216 associated with each layer within the model. These operators are useful for ensuring stable and effective processing of the data at each stage. The scale operator 214 may be configured to adjust the variance or spread of the activations in each layer. By multiplying the input features by a learned scaling factor, the scale operator 214 may be configured to normalize the values, preventing them from becoming too large or too small. This scaling process helps the model maintain stable activations, avoid issues like vanishing or exploding gradients, and ensures more consistent updates during training. The scaling factor is learned during the training process, allowing the model to adaptively control the contribution of different features, which improves the model's ability to capture relevant patterns.

Similarly, the shift operator 216 is used to adjust the mean of the activations in each layer. This operator can include adding a learned bias term to the feature values, centering the data, and ensuring that the activations are aligned in a meaningful way. This adjustment is useful for the model's ability to learn important patterns in the data by preventing the activations from being biased toward specific values. The shift operator 216 may ensure that the features are distributed in an optimal range, making it easier for the model to extract relevant information. Like the scaling factor 214, the shift operator 216 is also learned during training, enabling the model to adapt to the specific characteristics of the input data.

The scale and shift operators may be used to incorporate the temporal vector 202 and speaker embedding 114 into the data processing. These contextual inputs are used to adjust the normalization of activations as they pass through each layer. The temporal vector 202 and speaker embedding 114 may be combined, by summation, before being passed into the adaptive layer normalization layer 204. Instead of treating these inputs as separate entities, the adaptive layer normalization layer 204 may combine them to generate the scale and shift parameters. This combination allows the model to integrate both the time-dependent and speaker-specific information, making the learned features more context-aware.

With continued reference to FIG. 2, the diffusion model 200 can include a self-attention layer 206. In some implementations, the self-attention layer 206 is configured to capture the relationships and dependencies between different parts of the input data, specifically the noised latent representation 122. As the first layer of the diffusion model 200, the self-attention layer 206 may be configured to process the noised latent representation 122 by allowing the model to focus on various aspects of the input data simultaneously, regardless of their position within the data. The self-attention layer 206 may be configured to assist the model in distinguishing between the noise and the underlying structure of the latent representation by learning which features are most relevant to preserve and which can be ignored or removed. By incorporating self-attention in the first layer, the diffusion model 200 can process the entire input spectrum as a whole.

In an embodiment, the self-attention layer 206 may work by computing attention scores between each pair of positions in the input. Each position in the input, represented as a vector in the latent space, may be associated with a query, key, and/or value. The attention scores may be calculated by taking the dot product of the query of a given position with the keys of all other positions in the sequence, followed by a normalization step (often using softmax). These attention scores may be used to determine how much influence one part of the input should have on another during the processing of the data. Once the attention scores are computed, they are used to assign weighted values associated with each position in the noised latent representation 122. The weighted values may then be summed together, producing a new representation of the input where each position's output is influenced by the most relevant parts of the data according to the attention scores.

With continued reference to FIG. 2, the diffusion model 200 can include a first cross-attention layer 208. After the self-attention layer 206 processes the noised latent representation 122, the resulting output is passed into the first cross-attention layer 208. This layer is designed to receive additional conditioning inputs, such as the video embeddings 108. The first cross-attention mechanism works by learning how to attend to relevant parts of one input (the output from the self-attention layer) based on the conditioning inputs (e.g., the video embeddings 108). The output from the self-attention layer is enriched with contextual information through the cross-attention process, which helps the model adjust the noised latent representation 122 in alignment with the visual and temporal contexts. The layer achieves this by transforming the video embeddings 108 into query, key, and value representations, which are then used to compute attention scores with the self-attention output.

These attention scores may guide the model in focusing on the most relevant aspects of the input. Specifically, the conditioning data helps weight the self-attention output based on its relevance to the video context. For example, the video embeddings 108 may influence how the model interprets visual cues.

With continued reference to FIG. 2, the diffusion model 200 can include a second cross-attention layer 210. After the first cross-attention layer 206 processes the output of the self-attention layer 206, the resulting data may be passed into the second cross-attention layer 210. The second cross-attention layer 210 is designed to receive the textual embeddings 104. The second cross-attention mechanism operates similarly to the first, but with an emphasis on the textual embeddings 104 as the conditioning input. The textual embeddings represent the meaning or content of the text associated with the source video. The second cross-attention layer 210 may be used to transform the textual embedding 104 into query, key, and value representations, which are then used to compute attention scores with the output from the first cross-attention layer 208. These attention scores determine how much influence each part of the text and contextual input has on the processing of the noised latent representation 122.

By incorporating the textual embeddings 104, the second cross-attention layer 210 enables diffusion model 200 to refine the latent representation based on the semantic alignment with the text. This ensures that the generated output is consistent with the textual content, improving the overall coherence between the audio-visual features and the semantic meaning.

With continued reference to FIG. 2, the diffusion model 200 can include a multi-layer perception (MLP) layer 212. The output of the second cross-attention layer 210 may be passed into the MLP layer 212. The MLP layer may be designed to perform non-linear transformations and capture complex relationships in the data through its layered architecture. The MLP layer 212 can include multiple fully connected layers, each with activation functions that enable the model to learn more intricate representations of the data. The MLP layer 212 can include several hidden layers followed by an output layer that generates the final transformed representation.

The MLP layer 212 is configured to process the refined noised latent representation 122 from the second cross-attention layer 210, incorporating any remaining noise and contextual features. The adaptive layer normalization layer 204 may influence this process by adjusting the normalization based on the temporal vector 202 and speaker embedding 114. These inputs ensure that the MLP layer's 212 transformations remain aligned with the time-dependent aspects of the data and the speaker's unique characteristics.

With continued reference to FIG. 2, diffusion model 200 may be configured to be jointly optimized alongside the language model 106, video encoder 110, speaker encoder 116, and the like. The training process may be informed by the L2 loss between the generated noise 128A and the predicted noise 128B. This loss function provides a direct measure of how well the model is able to denoise the data and learn the underlying structure, guiding the model toward minimizing the discrepancy between the noise it generates and the noise it is expected to predict.

During training, the L2 loss may be calculated by comparing the generated noise (the noise predicted by the diffusion model during the denoising process) with the true noise (the actual noise that was added to the latent representation in the forward diffusion process). The L2 loss measures the mean squared error between the generated and true noise, which helps quantify how accurately the model is learning to reverse the added noise. The goal of the training process is to minimize this L2 loss, effectively teaching the model to generate the correct noise at each step of the denoising process.

Once the L2 loss is computed, backpropagation may be used to update one or more model parameters. The gradient of the L2 loss may be calculated with respect to the parameters of the diffusion model 200, the language model 106, the video encoder 110, the speaker encoder 116, and any other model disclosed herein. This ensures that the updates to each model are consistent with the shared objective of minimizing the noise discrepancy. During backpropagation, each of the models (e.g., the language model 106, video encoder 110, and speaker encoder 116) may adjust their parameters in a way that enhances their ability to provide more accurate conditioning embeddings, which, in turn, improves the denoising process in the diffusion model.

As the training progresses, the models may iteratively refine their ability to generate accurate noise predictions 128B and denoising transformations. Each update to the group of models' parameters may bring the models closer to accurately predicting the noise added during the diffusion process. The L2 loss between the generated and predicted noise provides a feedback loop that guides the models toward improved performance.

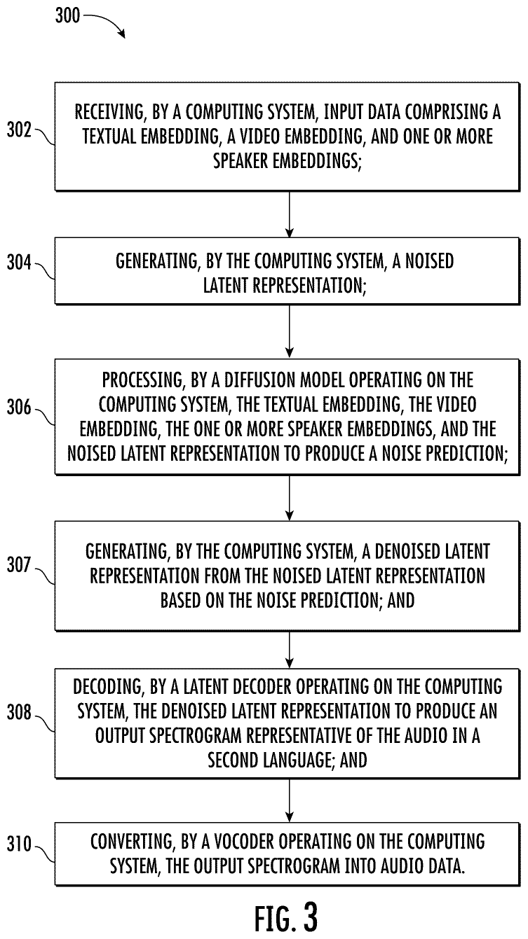

Referring now to FIG. 3, an exemplary embodiment of a flow diagram for a method for video-driven diffusion for cross-lingual dubbing.

At operation 302, the method includes receiving, by a computing device, input data including a textual embedding, a video embedding, and one or more speaker embeddings.

In an embodiment, receiving the input data can include receiving the textual embedding from a language model. This can include processing textual data, using a language model, to generate the textual embedding.

In an additional embodiment, receiving the input data can include receiving a video embedding from a video encoder. The video encoder may be configured to extract visual features from the video data. These visual features may then be transformed into a video embedding that is used in the cross-lingual dubbing process.

In a third embodiment, receiving the one or more speaker embeddings can include receiving the one or more speaker embeddings from a speaker encoder. This can include processing speaker reference data using a speaker encoder to generate the speaker embedding.

At operation 304, the method includes generating a noised latent representation. For example, the noised latent representation can be generated from a noise distribution. For example, the noise distribution can be a Gaussian distribution.

At operation 306, the method includes processing, by a diffusion model operating on the computing device, the textual embedding, the video embedding, the one or more speaker embeddings, and the noised latent representation to produce a noise prediction.

In an embodiment, the diffusion model can include two or more cross-attention layers. These layers allow the model to learn the relationships between various types of input embeddings, such as textual, video, and speaker embeddings. This cross-attention mechanism helps refine the model's output by weighing and combining features from different input sources to produce more accurate results. The two or more cross-attention layers can include a first cross-attention layer configured to process the video embedding, and a second cross-attention layer designed to process the textual embedding.

In an additional embodiment, the diffusion model can include an adaptive layer normalization layer. The adaptive layer normalization layer generates scale operators and shift operators for each layer within the diffusion model, based on the speaker embeddings and a temporal vector. These operators adjust the noise characteristics to better align with the specific speaker and the timing of the speech, ensuring that the model generates a more accurate and natural-sounding output.

The diffusion model may also include a self-attention layer. This layer may allow the model to focus on different parts of the input data independently. By attending to different features of the data simultaneously, the self-attention layer may be used to refine the output of the diffusion model.

Additionally, the diffusion model may incorporate a multi-layer perception (MLP) layer. The MLP layer may enable the diffusion model to learn more complex patterns and relationships between the input features. This capability allows the model to further refine its predictions.

At operation 307, the method includes generating a denoised latent representation from the noised latent representation based on the noise prediction. For example, operation 307 can include removing the predicted noise from the noised latent representation to update or “denoise” the latent representation. In some implementations, operations 306 and 307 can be performed iteratively over a number of diffusion time steps.

At operation 308, the method includes decoding, by a latent decoder operating on the computing device, the denoised latent representation to produce a second spectrogram representative of the audio in a second language.

At operation 310, the method includes converting, by a vocoder operating on the computing device, the second spectrogram into audio data.

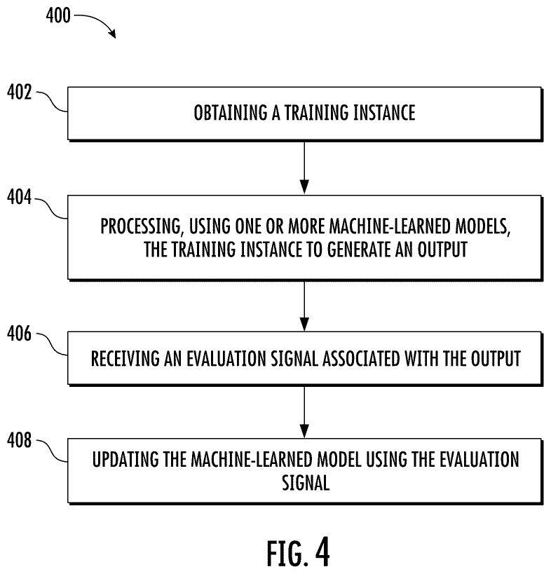

FIG. 4 depicts a flowchart of a method 400 for training one or more machine-learned models according to aspects of the present disclosure. For instance, an example machine-learned model can include a diffusion model 126, latent encoder 124, latent decoder 130, language model 106, video encoder 110, speaker encoder 116, and the like

One or more portion(s) of example method 400 can be implemented by a computing system that includes one or more computing devices such as, for example, computing systems described with reference to the other figures. Each respective portion of an example method 400 can be performed by any (or any combination) of one or more computing devices. Moreover, one or more portion(s) of example method 400 can be implemented on the hardware components of the device(s) described herein, for example, to train one or more systems or models. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of example method 400 can be performed additionally, or alternatively, by other systems.

At 402, example method 400 can include obtaining a training instance. A set of training data can include a plurality of training instances divided between multiple datasets (e.g., a training dataset, a validation dataset, or testing dataset). A training instance can be labeled or unlabeled. Although referred to in example method 400 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 404, example method 400 can include processing, using one or more machine-learned models, the training instance to generate an output. The output can be directly obtained from the one or more machine-learned models or can be a downstream result of a chain of processing operations that includes an output of the one or more machine-learned models.

At 406, example method 400 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 408, example method 400 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 400 can include implementing a number of generalization techniques (e.g., weight decays, dropouts, etc.) to improve the generalization capability of the models being trained.

In some implementations, example method 400 can be implemented for training a machine-learned model from an initialized state to a fully trained state (e.g., when the model exhibits a desired performance profile, such as based on accuracy, precision, recall, etc.).

In some implementations, example method 400 can be implemented for particular stages of a training procedure. For instance, in some implementations, example method 400 can be implemented for pre-training a machine-learned model. Pre-training can include, for instance, large-scale training over potentially noisy data to achieve a broad base of performance levels across a variety of tasks/data types.

In some implementations, example method 400 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 400 uses adapter layers. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 400 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

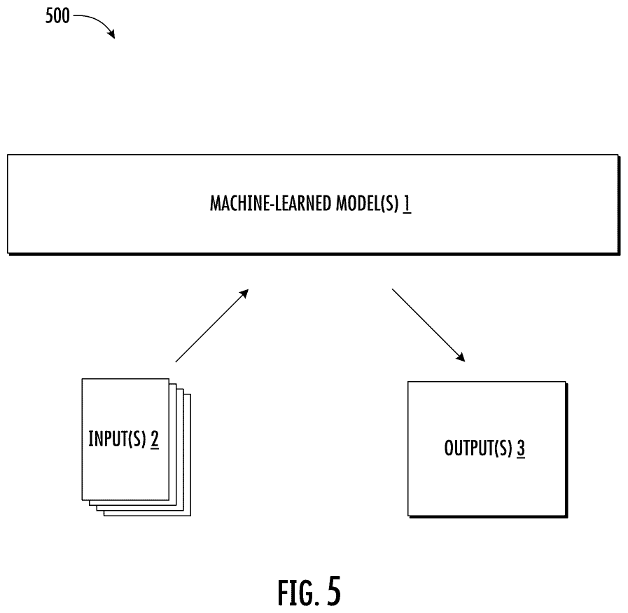

FIG. 5 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of diffusion model 126, latent encoder 124, latent decoder 130, language model 106, video encoder 110, speaker encoder 116, etc. Although various features, variations, and implementations described below are described with respect to machine-learned model(s) 1, it is to be understood that such features, variations, and implementations are to be understood as described with respect to each of diffusion model 126, latent encoder 124, latent decoder 130, language model 106, video encoder 110, speaker encoder 116, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

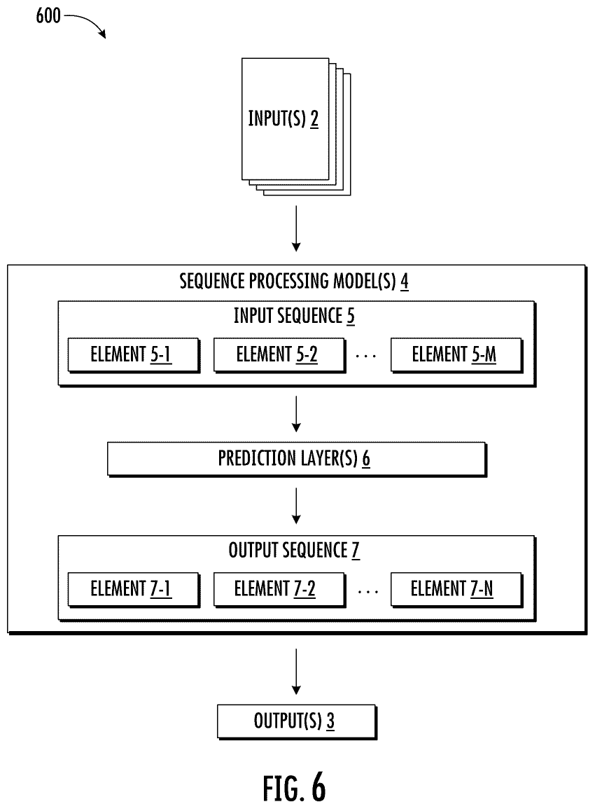

FIG. 6 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2,. 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 6 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

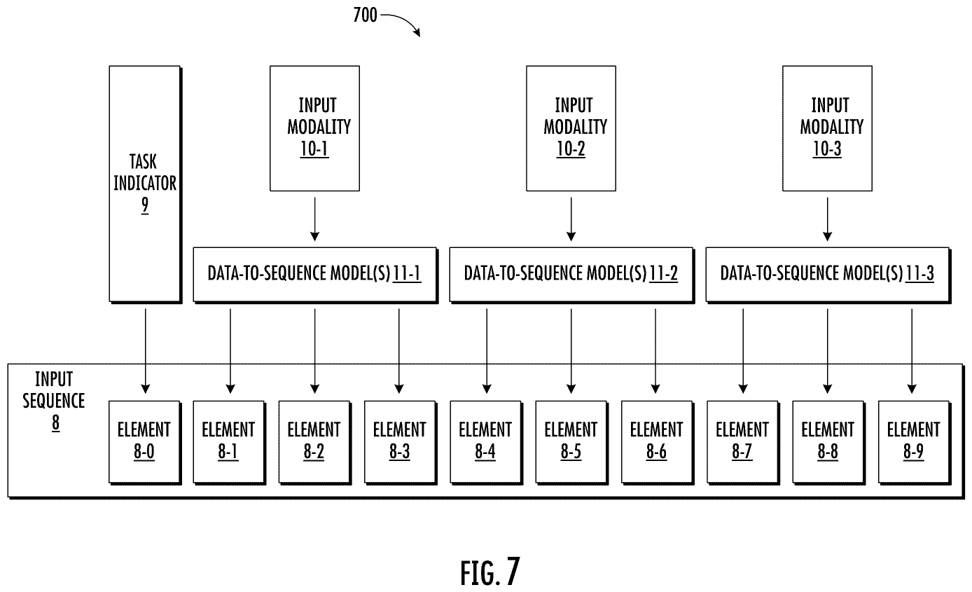

FIG. 7 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

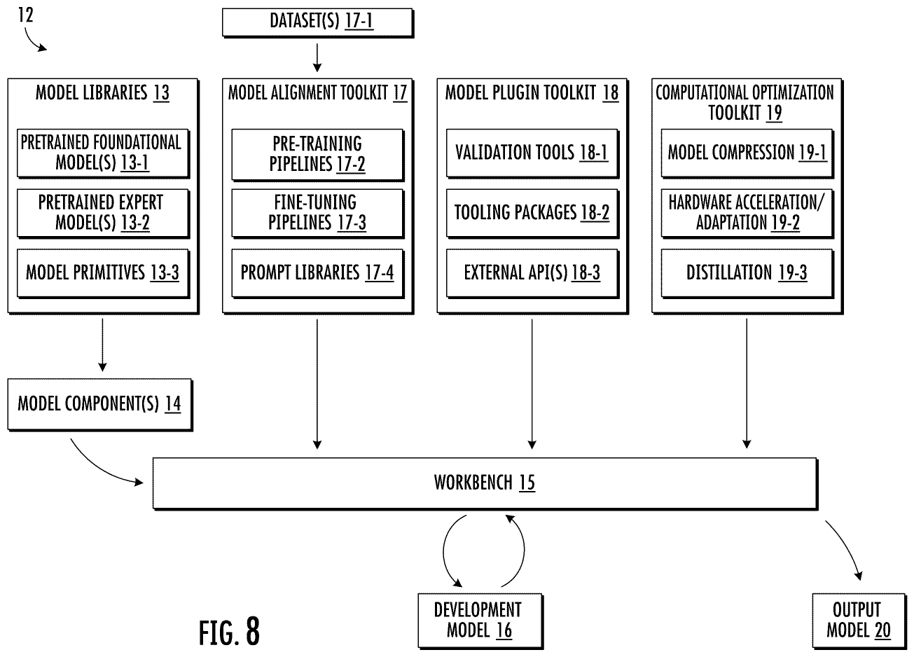

FIG. 8 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA layers that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 400 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models —e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

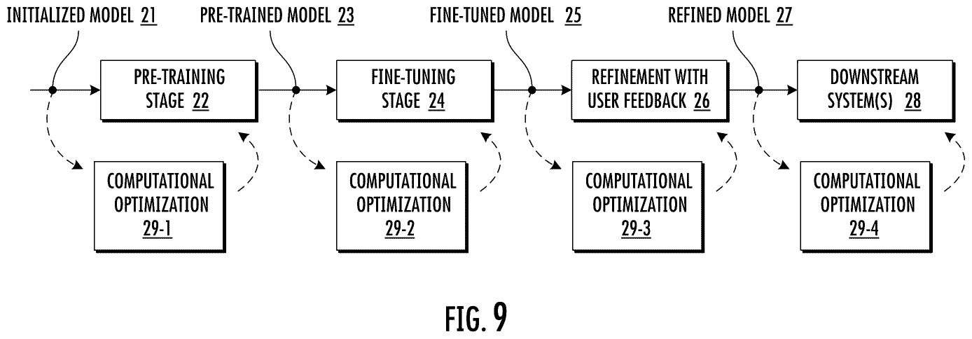

FIG. 9 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

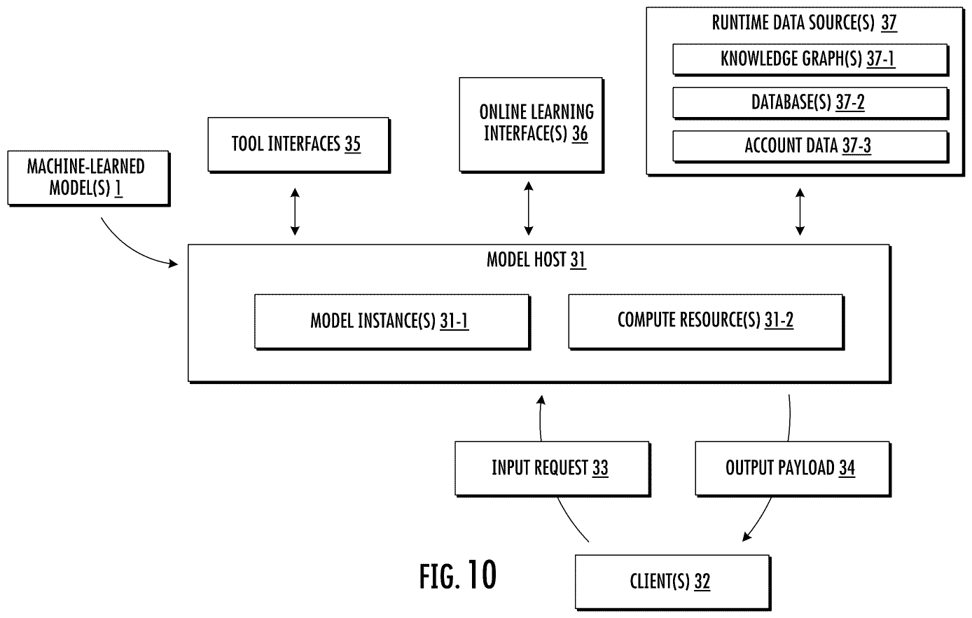

FIG. 10 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA layers that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input can include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

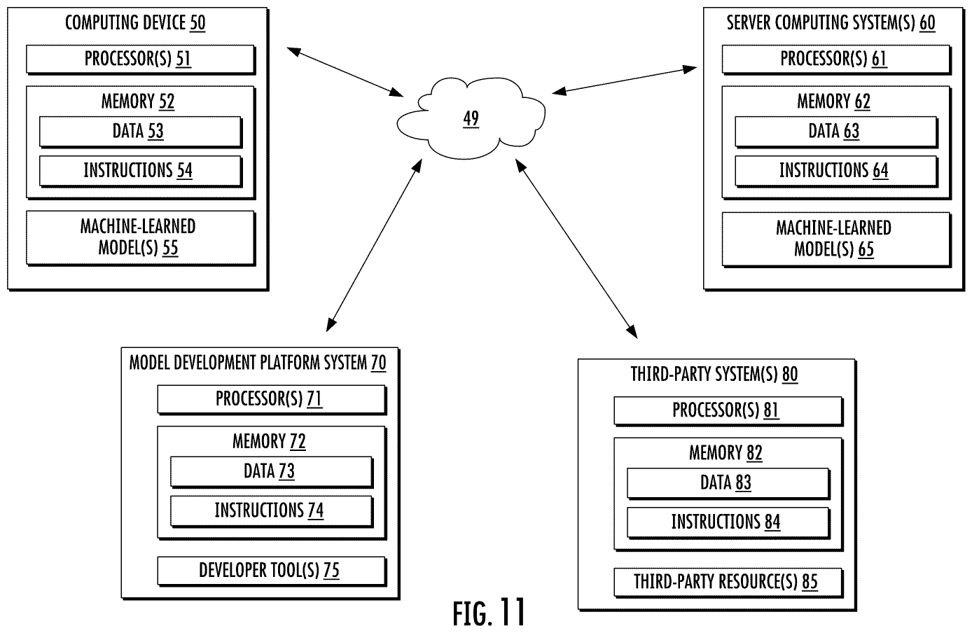

FIG. 11 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 11 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 11 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

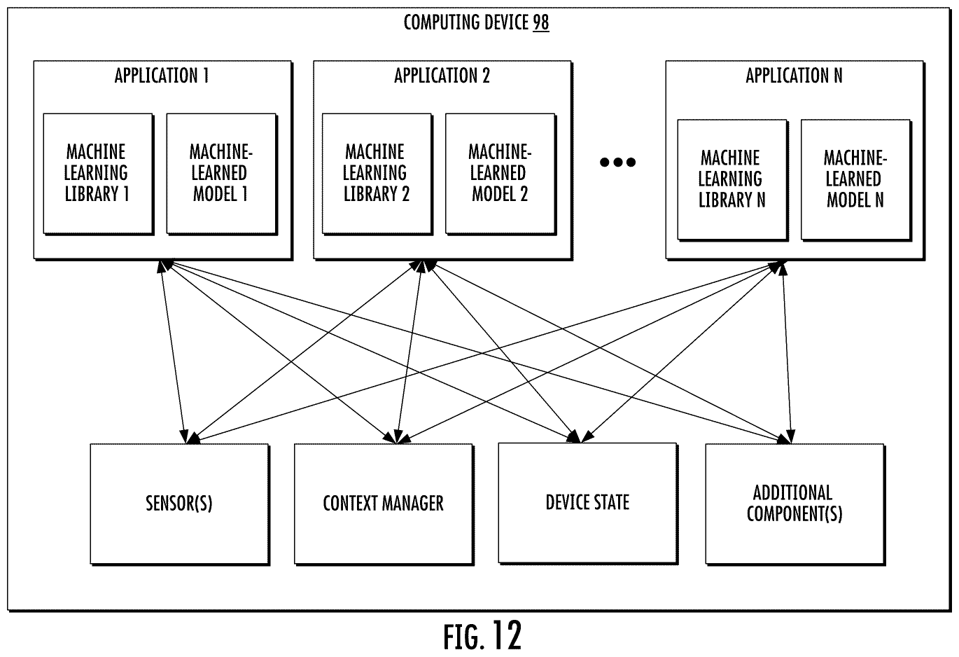

FIG. 12 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 12, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

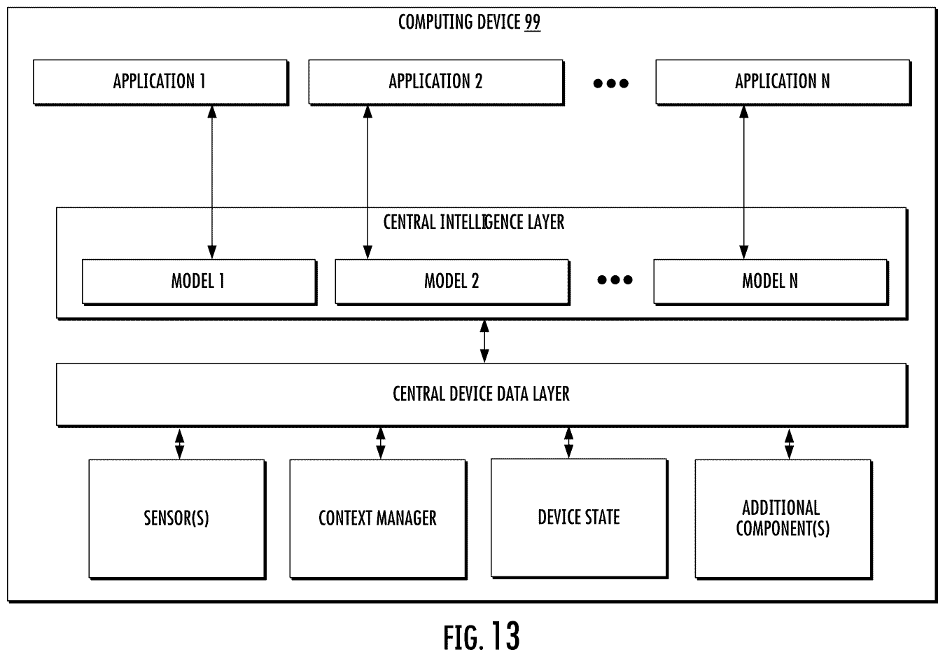

FIG. 13 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 13, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 13, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents. Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A computer-implemented method, comprising:
receiving, by a computing system, input data comprising a textual embedding, a video embedding, and one or more speaker embeddings;
generating, by the computing system, a noised latent representation;
processing, by a diffusion model operating on the computing system, the textual embedding, the video embedding, the one or more speaker embeddings, and the noised latent representation to produce a noise prediction;
generating, by the computing system, a denoised latent representation from the noised latent representation based on the noise prediction; and
decoding, by a latent decoder operating on the computing system, the denoised latent representation to produce an output spectrogram representative of audio data in a second language; and
converting, by a vocoder operating on the computing system, the output spectrogram into the audio data.

2. The computer-implemented method of claim 1, wherein the diffusion model comprises two or more cross-attention layers.

3. The computer-implemented method of claim 2, wherein the two or more cross-attention layers comprise:
a first cross-attention layer configured to process the video embedding; and
a second cross-attention layer configured to process the textual embedding.

4. The computer-implemented method of claim 1, wherein the diffusion model comprises an adaptive layer normalization layer configured to process the one or more speaker embeddings.

5. The computer-implemented method of claim 4, wherein the adaptive layer normalization layer is configured to generate one or more scale operators and one or more shift operators for each remaining layer within the diffusion model based on the one or more speaker embeddings and a temporal vector.

6. The computer-implemented method of claim 1, wherein receiving the textual embedding comprises processing, using a language model operating on the computing system, textual data to generate the textual embedding.

7. The computer-implemented method of claim 1, wherein receiving the video embedding comprises processing, using a video encoder operating on the computing system, a series of images associated with a video to generate the video embedding.

8. The computer-implemented method of claim 1, wherein receiving the one or more speaker embeddings comprises processing, using a speaker encoder operating on the computing system, speaker reference data to generate the one or more speaker embeddings.

9. The computer-implemented method of claim 8, wherein the speaker reference data comprises a speaker reference spectrogram.

10. A computing system, comprising:
one or more processors;
a diffusion model operating on the one or more processors; and
one or more transitory or non-transitory computer-readable media storing instructions that are executable to cause the one or more processors to perform operations, the operations comprising:
obtaining a source video comprising image content and audio content, the audio content comprising a speech utterance in a source language;
processing a noisy input with a machine-learned denoising diffusion model to generate a denoised output, wherein the machine-learned denoising diffusion model is conditioned on one or both of the image content and the audio content; and
generating output audio based on the denoised output, wherein the output audio comprises the speech utterance in a target language that is different from the source language.

11. The computing system of claim 10, wherein the noisy input comprises a noisy latent input and the denoised output comprises a denoised latent output.

12. The computing system of claim 10, wherein generating the output audio comprises: generating an output spectrogram based on the denoised output and generating the output audio based on the output spectrogram.

13. The computing system of claim 12, wherein generating the output spectrogram comprises processing the denoised output with a machine-learned decoder model; and
wherein generating the output audio based on the output spectrogram comprises processing the output spectrogram with a machine-learned vocoder model.

14. The computing system of claim 10, wherein the operations further comprise:
aligning the output audio with the image content to generate a dubbed video; and
one or more of: storing, transmitting, or causing playback of the dubbed video.

15. The computing system of claim 10, wherein the denoising diffusion model comprises one or more diffusion transformer blocks, and wherein at least one of the one or more diffusion transformer blocks performs cross-attention with feature data generated from the image content.

16. The computing system of claim 10, wherein the machine-learned denoising diffusion model is further conditioned on translated text data, the translated text data comprising a textual translation of the speech utterance into the target language.

17. A computing system, comprising:
one or more processors;
a diffusion model operating on the one or more processors; and
one or more transitory or non-transitory computer-readable media storing instructions that are executable to cause the one or more processors to perform operations, the operations comprising:
receiving input data, wherein receiving the input data comprises receiving:
a textual embedding from a language model;
a video embedding from a video encoder;
one or more speakers embeddings from a speaker encoder; and
a first spectrogram representative of an audio in a first language;
processing the first spectrogram to produce a noised latent representation, wherein processing the first spectrogram comprises introducing noise data into the first spectrogram;
processing, by the diffusion model, the textual embedding, the video embedding, the one or more speaker embeddings, and the noised latent representation to produce a noise prediction;
comparing the noise data to the noise prediction; and
jointly optimizing each of the language model, the video encoder, the speaker encoder, and the diffusion model based on the comparing.

18. The computing system of claim 17, wherein the diffusion model comprises:
a self-attention layer;
a first cross-attention layer configured to process the video embedding;
a second cross-attention layer configured to process the textual embedding;
a multi-layer perception layer; and
an adaptive layer normalization layer.

19. The computing system of claim 18, wherein the adaptive layer normalization layer is configured to generate one or more scale operators and one or more shift operators for each layer within the diffusion model based on the one or more speaker embeddings and a temporal vector.

20. The computing system of claim 17, wherein receiving the one or more speaker embeddings comprises processing, using a speaker encoder, speaker reference data to generate the one or more speaker embeddings.
